(19) United States
(12) Patent Application Publication
(10) Pub. No.: US 2002/0117226 A1
(43) Pub. Date: Aug. 29, 2002

(54) Reinforced corrugated tubing system

(76) Inventor: John A. Malcarne JR., Cochranville, PA (US)

Correspondence Address: CANTOR COLBURN, LLP, 55 GRIFFIN ROAD SOUTH, BLOOMFIELD, CT, 06002

(21) Appl. No.: 09/796,042

(22) Filed: Feb. 28, 2001

(51) Int. Cl. F16L 11/112

(52) U.S. Cl. 138/121; 138/125; 138/131; 138/134; 138/139; 138/143; 138/146

(57) ABSTRACT

Reinforced corrugated tubing comprising corrugated tubing having peaks and valleys and a reinforcement material disposed in the valleys. A method of reinforcing corrugated tubing comprises disposing a reinforcement material in valleys of the corrugated tubing.

### TECHNICAL FIELD

This disclosure relates generally to corrugated tubing and in particular to corrugated tubing with pressure reinforcement, vibration attenuation and high cycle life.

### BACKGROUND

Corrugated tubing or metal hose provides an alternative to rigid piping systems as a conduit for transporting fluids such as natural gas. The corrugated tubing can be easily installed and is useful in many system applications. Corrugated tubing allows for simpler more cost-effective installation due to its uniquely flexible structure and relatively high strength. The same flexibility has inherent limitations. As the internal pressure of the working fluid inside the tubing is increased the corrugated tubing structure reacts to the pressure. The typical corrugated tubing structure begins to spread and expand along its length when the internal pressure overcomes the strength of the tubing material. The higher pressures of the working fluid cause the corrugations to expand. The corrugation expansion results in a distortion of the tubing out of its original shape and size.

In order to meet higher operating pressure ranges, conventional corrugated tubing is sleeved with a wire braid. The braid is fixed at opposite ends of the corrugated tubing. The braid reinforces the corrugated tube structure thereby resisting the expansion of the corrugations when the internal pressure is increased. The braid is effective in the function of resisting the expansion of the corrugated tubing thereby increasing operational pressure capability. However, the braid covering the corrugated tubing outer diameter is subject to relative motion with the corrugated tubing that it covers. The tubing and the braid move relative to each other along the length of the corrugated tubing. In applications that plumb the corrugated tubing to mechanical equipment that create vibration translated to the tubing, the relative motion causes abrasion between the inside of the braid and the outer surface of the tubing. The abrasion between the tubing outer surface and the braid inner surface creates failure mechanisms that compromise the integrity of the corrugated tubing structure. The braid saws and rubs off the outer surface material of the corrugated tubing until the tubing pressure boundary fails and subsequently leaks the working fluid.

Conventional corrugated tubing also may include a topically applied jacket that serves to protect the tubing from its external environment. The jacket also provides a surface to apply marking such as pressure ratings, manufacturer, etc. These topically applied jackets, however, do not provide pressure reinforcement and are not intended to do so.

### SUMMARY

The drawbacks and deficiencies of the prior art are overcome or alleviated by a reinforced corrugated tubing system. Reinforced corrugated tubing is disclosed comprising corrugated tubing and a reinforcement material deposited between the corrugations of the tubing. A method of reinforcing corrugated tubing is also disclosed comprising disposing a reinforcement material in the corrugations.

The above discussed and other features and advantages of the reinforced corrugated tubing will be appreciated and understood by those skilled in the art from the following detailed description and drawings.

### BRIEF DESCRIPTION OF THE DRAWINGS

Referring now to the drawings wherein like elements are numbered alike in the several FIGURES:

FIG. 1 is a cross-sectional side view of reinforced corrugated tubing;

FIG. 2 is a side partial cross-sectional view of a fitting attached to the reinforced corrugated tubing.

### DETAILED DESCRIPTION

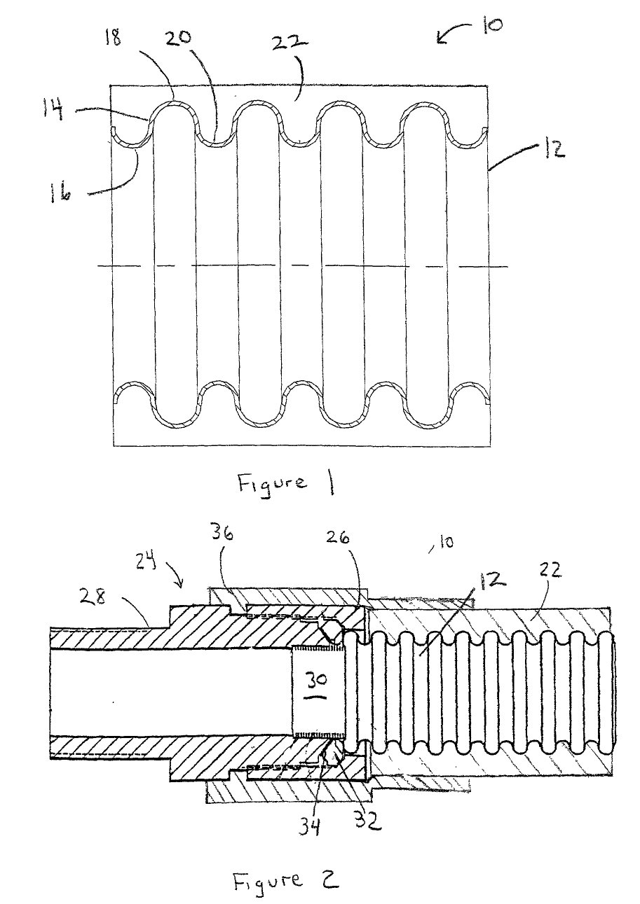

FIG. 1 is a cross-sectional side view of reinforced corrugated tubing 10. The reinforced corrugated tubing 10 comprises corrugated tubing 12 which, in the embodiment of FIG. 1, is annular tubing. It is understood that the reinforcement material may be applied to other types of corrugated tubing such as helical tubing. The corrugated tubing 12 has an exterior surface 14 and an interior surface 16. The interior surface 16 typically is exposed to the working fluid. The corrugated tubing 12 comprises a structure that has varying diameters or convolutions that form peaks 18 and valleys 20 in alternating series along the length of the corrugated tubing 12. The exterior surface 14 is used as the reference for the peak 18 and valley 20 as opposed to the interior surface 16. The peak 18 consists of the convolution with the larger outside diameter and the valley 20 consists of the convolution with the smaller outside diameter.

A reinforcement material 22 is disposed on the exterior surface 14 of the corrugated tubing 12. The reinforcement material 22 substantially fills the valleys 20 and covers the peaks 18 on the exterior surface 14. The reinforcement material 22 is disposed along the length of the corrugated tubing 12. The material makeup of the reinforcement material 22 has properties that resist forces that distort the material such as tension and shear forces. As a result, when the internal pressure of a working fluid increases and acts to spread apart the corrugated tubing 12 the reinforcement material 22 disposed in the valleys 20 of exterior surface 14 resists the forces that are created. The reinforcement material 22 inhibits the expansion or spreading of the corrugated tubing 12 such that the corrugated tubing 12 does not significantly distort either in the linear dimension or the diameter of the corrugated tubing 12. The reinforcement material 22 supports each convolution of the corrugated tubing 12. The material makeup of the reinforcement material 22 is also resilient and flexible. As the corrugated tubing 12 is bent and flexed along its length, the reinforcement material 22 bends and flexes with the corrugated tubing 12. The reinforcement material 22 allows the corrugated tubing 12 to flex, and in some embodiments the reinforced corrugated tubing 10 can be flexed into a knot.

The thickness of the reinforcement material 22 can be varied to enhance resistance to tube expansion or to provide more or less flexibility to the corrugated tubing 12. A variety of pressure ratings can be met by changing the thickness of the reinforcement material 22. A direct relationship exists between the thickness of the reinforcement material 22 and the pressure rating of the corrugated tubing 12. Applying a reinforcement material 22 to the corrugated tubing 12 increases the pressure rating of the corrugated tubing 12 above the pressure rating of the corrugated tubing 12 without a reinforcement material 22. The reinforcement material 22 also increases the number of flex cycles required to create metal fatigue failure in the corrugated tubing 12 and attenuates vibration to reduce failure of corrugated tubing 12 due to vibration fatigue.

In one embodiment, the reinforcement material comprises medium density polyurethane. The material composition of the reinforcement material 22 can be any material that has the physical properties to resist deformation as well as be compatible with the metallic materials of the corrugated tubing 12. Other materials are contemplated that possess both resistance to distortion forces such as shear and tension and possess flexibility as well as adhesive properties. The material of the reinforcement material 22 can be compatible with any metallic corrugated tubing such as 300 series stainless steel corrugated tubing 12. The reinforcement material 22 can also protect the material of the corrugated tubing 12 from degradation as a result of exposure to harsh environments; the same protection provided by conventional jackets. Co-polyesters, polyethylene, stabilized polymers, non-chlorinated polymers and non-halogenated polymers and in general polymers can be used.

The reinforcement material 22 can be extruded into the corrugations of corrugated tubing 12. The use of other manufacturing processes can be employed to dispose the reinforcement material 22 onto the exterior surface 14 of the corrugated tubing 12. In one embodiment, the reinforcement material 22 is driven into the valleys 20 to substantially fill valleys 20 and covers peaks 18. As the reinforcement material 22 is extruded it is substantially molten and flows down into the corrugations of the corrugated tubing 12. The molten reinforcement material 22 cools on the corrugated tubing 12. The molten reinforcement material substantially fills the valleys 20 and covers the peaks 18. In an alternate embodiment, a polymer reinforcement material 22 is extruded down into the corrugations and then cured (e.g., through heat).

The reinforcement material 22 may be applied so that the reinforcement material 22 bonds to substantially the entire exterior surface 14. The optional bonding of the reinforcement material 22 to the exterior surface 14 can be mechanical bonding or chemical bonding such that reinforcement material 22 substantially adheres to the exterior surface 14 of the corrugated tubing 12. Also, by being located in the valleys 20, the reinforcement material 22 mechanically blocks the deformation of the corrugated tubing 12 as a result of the material properties of the reinforcement material 22. With the reinforcement material 22 applied such that there is an adhesion between the reinforcement material 22 and the surface of the corrugated tubing 12, there is no relative motion between the reinforcement material and the surface of the corrugated tubing 12. Having eliminated the relative motion between the reinforcement material 22 and the exterior surface 14, the abrasive wear mechanism is substantially eliminated while still providing pressure reinforcement.

FIG. 2 is a side view, in partial cross-section, illustrating the field attachable installation of a fitting 24 onto the reinforced corrugated tubing 10. The fitting 24 can have a nut 26 disposed on a body 28. The fitting 24 can have a locating sleeve 30. Included with the fitting 24 is at least one split ring washer 32. The body can comprise many materials including brass and brass alloys as well as many carbon steels, such as C12L14 carbon steel.

The fitting 24 can be field mounted as follows. The reinforcement material 22 disposed on the corrugated tubing 12 is removed sufficiently enough to expose at least a valley 20 of a convolution. The corrugated tubing can be cut at that valley 20 with a pipe cutter on the exterior surface 14. The nut 26 is placed over the corrugated tubing 12 and two split ring washers 32 are placed in the first valley 20 adjacent to the cut end. The locating sleeve 30, which is connected to the body 28, can be placed in the corrugated tubing 12. The locating sleeve 30 ensures that the central axis of the body 28 is aligned with the central axis of the corrugated tubing 12. The nut 26 is then tightened on a first threaded end of the body 28. As the nut 26 is tightened, the corrugated tubing 12 at the outside of the split ring washers 32 (e.g. near the cut end of the corrugated tubing 12) is folded upon itself and flared outwardly by a tapered portion 34 of the body 28. The corrugated tubing 12 is compressed between the tapered portion 34 and the split ring washers 32 and a leak proof seal is achieved. With the fitting 24 coupled to the reinforced corrugated tubing 10, the reinforced corrugated tubing 10 can be coupled with other reinforced corrugated tubing 10 or devices. The fitting 24 can also be coupled to the corrugated tubing 12 by welding techniques. The welding attachment can be pre-fitted. With the fitting 24 welded to the corrugated tubing 12 certain elements can be eliminated from the fitting 24 such as the nut 26 and the split ring washers 32.

A sleeve 36 is shown in FIG. 2 disposed on the fitting 24 and the reinforcement material 22 over the corrugated tubing 12. The sleeve 36 provides a strain relief between the interface of the fitting 24 and the corrugated tubing 12. Strain relieving provides additional reinforcement to the interface between the corrugated tubing 12 and fitting 24. The strain relief redistributes the stresses away from the interface or attachment area of the fitting 24 and the corrugated tubing 12 out to the fitting 24 and the corrugated tubing 12. The additional reinforcement allows the corrugated tubing 12 with the fitting 24 to operate at higher service pressures. The sleeve 36 also provides an additional boundary around the corrugated tubing 12 inhibiting the exposure to harsh environments. The sleeve 36 can comprise plastic in one embodiment, but any material that can provide structural support for the fitting 24 and the reinforced corrugated tube 12 may be utilized. The sleeve 36 made of a metal is also contemplated. The sleeve 36 can be applied by use of heat shrinking in one embodiment, and in another the sleeve is welded to the fitting 24. The sleeve 36 is disposed so that a sufficient coverage of both the fitting 24 and the reinforcement material 22 is achieved.

While preferred embodiments have been shown and described, various modifications and substitutions may be made thereto without departing from the spirit and scope of the invention. Accordingly, it is to be understood that the reinforced corrugated tubing has been described by way of illustration and not limitation.

What is claimed is:

1. A reinforced metal corrugated tubing comprising:
a corrugated tubing having an outer surface including convolutions of peaks and valleys;
a reinforcement material disposed in said valleys.

2. The reinforced corrugated tubing of claim 1 wherein said reinforcement material comprises a material that is resistant to distortion forces.

3. The reinforced corrugated tubing of claim 1 wherein said reinforcement material supports each convolution to reduce distortion of said convolutions.

4. The reinforced corrugated tubing of claim 1 wherein said reinforcement material is disposed on substantially all of said outer surface of said corrugated tubing.

5. The reinforced corrugated tubing of claim 1 wherein said reinforcement material substantially fills the valleys and substantially covers the peaks.

6. The reinforced corrugated tubing of claim 1 wherein said tubing is corrugated metallic tubing.

7. The reinforced corrugated tubing of claim 1 wherein said reinforcement material comprises a polymer.

8. The reinforced corrugated tubing of claim 1 wherein said reinforcement material increases the number of flex cycles required to create metal fatigue failure in the corrugated tubing.

9. The reinforced corrugated tubing of claim 1 wherein said reinforcement material attenuates vibration to reduce failure due to vibration fatigue.

10. The reinforced corrugated tubing of claim 1 wherein said reinforcement material prevents said convolutions from substantially distorting when pressurized by a working fluid.

11. The reinforced corrugated tubing of claim 1 wherein said reinforcement material thickness is related to a pressure rating of said corrugated tubing.

12. The reinforced corrugated tubing of claim 1 wherein said reinforcement material allows said corrugated tubing to flex.

13. The reinforced corrugated tubing of claim 1 further comprising:
a fitting coupled to said corrugated tubing at an end thereof.

14. The reinforced corrugated tubing of claim 13 further comprising:
a sleeve disposed on said fitting and said reinforcement material to provide strain relief.

15. The reinforced corrugated tubing of claim 1 wherein said reinforcement material is chemically bonded to said outer surface.

16. The reinforced corrugated tubing of claim 1 wherein said reinforcement material is mechanically bonded to said outer surface.

17. A method of reinforcing corrugated tubing having an outer surface including convolutions of peaks and valleys, the method comprising:
disposing a reinforcement material on said corrugated tubing, said reinforcement material being positioned in a plurality of said valleys.

18. The method of reinforcing corrugated tubing of claim 17 wherein said reinforcement material is extruded onto said corrugated tubing.

19. The method of reinforcing corrugated tubing of claim 17 wherein said reinforcement material substantially fills said valleys and substantially covers said peaks and said reinforcement material supports said convolutions.

20. The method of reinforcing corrugated tubing of claim 17 wherein said reinforcement material mechanically bonds to said corrugated tubing.

21. The method of reinforcing corrugated tubing of claim 17 wherein said reinforcement material chemically bonds to said corrugated tubing.

22. A method of making a reinforced corrugated tubing comprising:
extruding a reinforcement material over the corrugated tubing, said corrugated tubing having convolutions of peaks and valleys;
driving the reinforcement material into the valleys;
attaching a fitting to the corrugated tubing; and
disposing a sleeve over said reinforcement material and said fitting.

23. The method of making a reinforced corrugated tubing of claim 22 wherein said driving the reinforcement material includes substantially filling said valleys with said reinforcement material.

24. The method of making a reinforced corrugated tubing of claim 22 wherein said reinforcement material comprises a polymeric material.

25. The method of making a reinforced corrugated tubing of claim 22 wherein said reinforcement material mechanically bonds to said corrugated tubing.

26. The method of making a reinforced corrugated tubing of claim 22 wherein said reinforcement material chemically bonds to said corrugated tubing.
